(19) United States
(12) Patent Application Publication
(10) Pub. No.: US 2016/0283894 A1
(43) Pub. Date: Sep. 29, 2016

(54) LOCATION-BASED ALUMNUS BUSINESS BUILDING SYSTEM AND METHOD

(71) Applicant: Seong Hyeon LEE, Chungcheongbuk-do (KR)

(72) Inventor: Seong Hyeon LEE, Chungcheongbuk-do (KR)

(21) Appl. No.: 15/036,942

(22) PCT Filed: Aug. 25, 2014
(86) PCT No.: PCT/KR2014/007852

§ 371 Date: May 16, 2016

(30) Foreign Application Priority Data
Mar. 7, 2014 (KR) 10-2014-0026980

(51) Int. Cl. G06Q 10/06; H04W 4/12; H04W 4/00; G06Q 10/10

(52) U.S. Cl. CPC G06Q 10/063118; G06Q 10/1095; G06Q 10/1053; H04W 4/12; H04W 4/008

(57) ABSTRACT

A location-based alumnus business building system and method are provided. The location-based alumnus business building system according to an embodiment of the present invention comprises an information management server for building a business between alumni members who graduated from a particular school. The information management server is linked to Web and an application of a mobile device such as a smart phone, a smart watch, or a tablet PC. The information management server includes an alumni information management unit, a history information management unit, a business management unit, a feedback management unit, a level management unit, a schedule information management unit, a status information management unit, a location information management unit, an open location management unit, and a location information display unit.

### TECHNICAL FIELD

The present invention relates to a location-based alumnus business building system and method, and more particularly, to a system and method for mutually exchanging business, marketing, information, and knowhow by utilizing location information between alumni and providing feedback on mutual exchanges.

### BACKGROUND ART

Owing to the development of wireless telecommunication and community means, etc., social networking services (SNSs) have been rapidly developed. However, SNSs such as Facebook, Twitter, Pinterest, Google Plus, etc., abuse friend recommendations irrespective of offline relationships between users, which causes an increase in the number of persons who avoid use of SNSs.

To overcome such a limitation of the SNSs, a “closed SNS” for sharing information only between users who have been acquainted with one another offline has been emerged. Services such as Naver Band, Member, Pass, etc. have been spotlighted locally and internationally. However, just personal information is shared on such a closed SNS and the closed SNS fails to provide substantial information regarding a current location of a user who belongs to same SNS and to generate synergy between users.

### PRIOR ART

(Patent Document 1) KR 10-1273633 (Jun. 11, 2013)

### ABSTRACT OF THE INVENTION

### Technical Problem

To solve and overcome the technical problem described above, the present invention provides a system and a method for mutually exchanging business, marketing, information, and knowhow based on location information between users affiliated to a social networking service (SNS) and providing feedback on mutual exchanges.

To solve another technical problem, the present invention provides offline business reliability information of alumni to an online or SNS based on an alumnus organization.

The technical problems solved by the present invention are not limited to those described above. Other technical problems that are not mentioned may be clearly understood by one of ordinary skill in the art from the description below.

### Technical Solution

According to an embodiment of the present invention, there is provided a location-based alumnus business building system comprising an information management server for building business between alumni members who graduated from a particular school, wherein the information management server is linked to Web and an application of a mobile device comprising a smart phone, a smart watch, or a tablet PC, wherein the information management server comprises: an alumni information management unit configured to manage one or more pieces of alumni information among a graduation school name of an alumni member, an entrance year, a graduation year, a past photo, a major, a nickname, a graduation year number, liberal arts or natural sciences, a class number for each year, a name of a class teacher or a nick name thereof, and a name of a teacher who is remembered or a nick name thereof; a history information management unit configured to manage one or more pieces of history information among a job of the alumni member, a job group, a function, a rank, a responsible work, a main career, a license, and a motto; a business management unit configured to manage one or more pieces of business information among a theme of business requiring help of another alumni member in association with the job of the alumni member or the responsible work, advice on the business, information arranging a meeting regarding the business, and place information of the meeting; a feedback management unit configured to manage a review on business between alumni members, episode, or a service evaluation; a level management unit configured to control an information access by dividing a member authority based on one or more pieces of information among business proposal number of times of an alumni member, a business activity number of times, a business evaluation score, a preference score, and a feedback score and manages a level of the alumni member to show an alumni member of a different alumni group who graduated from a different school on a new map according to the level; a schedule information management unit configured to manage schedule information of the alumni member; a status information management unit configured to manage one or more pieces of status information among a meeting status of the alumni member, a driving status, a working status, a consulting status, a lecturing status, a tired status, a gloomy status, a busy status, a leisure status, and a conversation available status; a location information management unit configured to manage location information of the alumni member; an open location management unit configured to manage an open location information such that when the alumni member sets current location information to open to other alumni members, the current location information is open, and when the alumni member sets the current location information not to open to other alumni members, preselected particular location information for each time zone is open; and a location information display unit configured to display open location information of the alumni member on a screen as a map for one or more alumni groups among an elementary school alumni group, a middle school alumni group, a high school alumni group, an undergraduate school alumni group, and a graduate school alumni group, wherein the business management unit or the schedule information management unit is further configured to notify business information or schedule information to alumni members who share the business information or the schedule information via e-mail or a push message of the mobile device.

The location-based alumnus business building system may further include: an alumni recommendation unit configured to recommend alumni members of a different alumni group who graduated from a different school according to the level divided by the level management unit and, if the alumni members permit to open each other's information, the alumni recommendation unit is configured to show the alumni members on a new map to have a business relationship.

The open location management unit, when another alumni member enters a region indicated by the open location information, is further configured to notify information including a fact that another alumni member is present in the region to the alumni member via e-mail or a push message of the mobile device.

According to another embodiment of the present invention, there is provided a location-based alumni business building method of building business between alumni members by using the location-based alumni business building system, the location-based alumni business building method comprising: setting, by the information management server, one or more alumni groups among an elementary school alumni group, a middle school alumni group, a high school alumni group, an undergraduate school alumni group, and a graduate school alumni group in relation to alumni information of the alumni member; managing, by the information management server, an open location information such that when the alumni member sets current location information to open to another alumni member, the current location information is open, and when the alumni member sets the current location information not to open, preset particular location information for each time zone is open; providing, by the information management server, open location information of the alumni member to another alumni member on a map of a screen for one or more alumni groups among the elementary school alumni group, the middle school alumni group, the high school alumni group, the undergraduate school alumni group, and the graduate school alumni group; providing, by the information management server, business information required by the alumni member to another alumni member; notifying, by the information management server, the business information or schedule information to alumni members who share the business information or the schedule information via e-mail or a push message of the mobile device; providing, by the information management server, feedback including a review of business of the alumni member, an episode, or a service evaluation; and controlling, by the information management server, an information access by dividing a member authority based on one or more pieces of information among business proposal number of times of the alumni member, a business activity number of times, a business evaluation score, a preference score, and a feedback score and managing a level of the alumni member to show an alumni member of a different alumni group who graduated from a different school on a new map according to the level.

The location-based alumnus business building method may further include: recommending, by the alumni recommendation unit, alumni members of a different alumni group who graduated from a different school according to the level divided in the managing of the level, and, if the alumni members permit to open each other's information, showing, by the alumni recommendation unit, the alumni members on a new map to have a business relationship.

The location-based alumnus business building method may further include: when another alumni member enters a region indicated by the open location information, notifying, by the alumni recommendation unit, information including a fact that another alumni member is present in the region to the alumni member via e-mail or a push message of the mobile device.

### Advantageous Effects of the Invention

According to the present invention as described above, an alumnus relationship-based reliable closed SNS may be possible. Location based alumnus information may be determined, and thus, support for an effective business development is possible. Additionally, an open location information is limited, thereby blocking indiscreet leakage of personal information.

### BEST MODE

Hereinafter, exemplary embodiments of the invention will be described. The advantages and features of the present invention and methods of achieving the advantages and features will be described more fully with reference, in which exemplary embodiments of the invention are shown. The invention may, however, be embodied in many different forms and should not be construed as being limited to the embodiments set forth herein; rather these embodiments are provided so that this disclosure will be thorough and complete, and will fully convey the concept of the invention to one of ordinary skill in the art. Like reference numerals refer to like elements throughout.

Unless otherwise defined, all terms (including technical and scientific terms) used herein have the same meaning as commonly understood by one of ordinary skill in the art to which exemplary embodiments belong. It will be further understood that terms, such as those defined in commonly used dictionaries, should be interpreted as having a meaning that is consistent with their meaning in the context of the relevant art and will not be interpreted in an idealized or overly formal sense unless expressly so defined herein.

The terms used in the present specification are merely used to describe particular embodiments, and are not intended to limit the present invention. An expression used in the singular encompasses the expression of the plural, unless it has a clearly different meaning in the context. It will be further understood that the terms “comprises” and/or “comprising” used herein do not preclude the presence or addition of one or more other features or components.

A location-based alumnus business building system and method according to embodiments of the present invention will now be described below.

The location-based alumnus business building system according to an embodiment of the present invention is a system that includes an information management server S for supporting a business building between alumni members who graduated from a particular school, wherein the information management server S is linked to the Web and an application of a mobile device such as a smart phone, a smart watch, or a tablet PC. Most of human social life such as business, study, politics, research, etc. cannot take place alone. To solve problems of such social life, the most used method worldwide is to utilize a network between school seniors and juniors. As alumni information is not efficiently utilized, although there is a sufficient demand for utilizing an alumni network, an alumnus related service has not been greatly spotlighted due to a problem of a service configuration. Although an alumni community service such as Iloveschool, etc. has been once quite popular, the service disappeared since it failed to create a value more than a mere community. At present, 10 years later, no general purpose alumni based service has been developed. However, a location limitation has been removed owing to the development of mobile devices, and an environmental foundation for an alumni based network service has been provided.

The location-based alumnus business building system according to an embodiment of the present invention includes the information management server S for building business between alumni members who graduated from the particular school, wherein the information management server S is linked to the Web and the application of the mobile device such as the smart phone, the smart watch, or the tablet PC. The information management server S includes a personal information management unit that manages one or more pieces of personal information among an identifier of an alumni member, a name, a birthday, a mobile phone number, a phone number, an email address, an address, a current photo, and a name card photo, a history information management unit that manages one or more pieces of history information among a job of the alumni member, a job group, a function, a rank, a responsible work, a main career, a license, and a motto, an alumni information management unit that manages one or more pieces of alumni information among a graduation school name of the alumni member, an entrance year, a graduation year, a past photo, a class number, a major, a nickname, a graduation year number, liberal arts and natural sciences, a class number for each year, a name of a class teacher or a nick name, and a name of a teacher who is remembered or a nick name thereof, a social information management unit that manages one or more pieces of social information among a blog address of the alumni member, a messenger identifier, a personal home page address, and a social network page address, a location information management unit that manages location information of the alumni member, a location information display unit that displays open location information of the alumni member on a screen as a map for one or more alumni groups among an elementary school alumni group, a middle school alumni group, a high school alumni group, an undergraduate school alumni group, and a graduate school alumni group, a schedule information management unit that manages schedule information of the alumni member, a status information management unit that manages one or more pieces of status information among a meeting status of the alumni member, a driving status, a working status, a consulting status, a lecturing status, a tired status, a gloomy status, a busy status, a leisure status, and a conversation available status, a business management unit that manages one or more pieces of business information among a theme of business requiring help of another alumni member in association with the job of the alumni member or the responsible work, advice on the business, information arranging a meeting regarding the business, and place information of the meeting, and an open setting unit that manages whether to open one or more pieces of information among the personal information, the history information, the alumni information, the social information, the schedule information, and the business information.

The personal information management unit may manage the one or more pieces of personal information among the identifier of the alumni member, the name, the birthday, the mobile phone number, the phone number, the email address, the address, the current photo, and the name card photo. The identifier may be an ID identifying the alumni member and another alumni member. The name may be a Korean name of the alumni member, an English name, a name in Chinese characters, a nickname, etc. The birthday may include an actual birthday of the alumni member or a birthday indicated in an ID card. An entrance year, a graduation year, etc. may be estimated based on the birthday. The mobile phone number, the phone number, the email address, and the address may be stored in the present system and provided to a particular member, and thus another alumni member using the present invention may communicate using the mobile phone number, the phone number, the email address, and the address of the alumni member through various communication means. The current photo and the name card photo may be a means for acknowledging an identity between the alumni member and another alumni member by storing a current appearance of the alumni member in the system and providing the stored current appearance to another alumni member.

The personal information management unit may encrypt the personal information item in order to reinforce security. Personal information on application and the Web is easily leaked. In particular, alumni information may be used not only for marketing but also for crimes such as fraud, etc., and thus the personal information item should be encrypted. A symmetrical encryption type secret key encryption method (DES) and an asymmetrical encryption type public key encryption method (RSA) may be used. The secret key encryption method has a fast encryption speed and a small quantity and thus is economical. The public key encryption method separately manages a public key and a secret key, and thus a key management is easy, and encryption and user authentication are simultaneously performed. The personal information management unit may further include an encryption unit that is in charge of a personal information encryption process described above.

The personal information management unit may further include an identity acknowledging unit capable of acknowledging an identity of an information reader. When an action to search for or read information of a particular alumni member occurs, a step of acknowledging an identity of the corresponding user may be additionally set. A user who searches for or reads information of the particular alumni member may not be an alumni member, and thus a step of authenticating the identity acknowledging unit is necessary. Authentication of the identity acknowledging unit may be performed through matching with data of an external database. The external database may be school information such as school graduate information, school student information, school major information, school advisor professor information, and school class teacher information, and may be a general database such as ID acknowledgement database.

It may be a problem when an alumni member reads information of the alumni member without permission of the corresponding member, and thus the personal information management unit may further include a reading management unit that transmits a reading permission message to an alumni member who is a reading target when an action to read information of a particular alumni member occurs and allows reading only when a feedback of the reading permission message is received. The reading management unit may manage a reading fact with respect to personal information, a notification fact, reading permission information, etc.

The personal information management unit may further include a log management unit that records log information regarding whether to read personal information to a server such that an alumni member may acknowledge a user who reads his/her personal information and provides the log information to each alumnus member such that all alumni members may acknowledge users who read their personal information.

The alumni information management unit may manage the one or more pieces of alumni information among the graduation school name of the alumni member, the entrance year, the graduation year, the past photo, the major, the nickname, the graduation year number, liberal arts or natural sciences, the class number for each year, the name of the class teacher or the nick name, and the name of the teacher who is remembered or the nick name. Since the alumni information management unit stores and manages the graduation school name of the alumni member, the entrance year, and the graduation year, although the personal information of the alumni member handled by the personal information management unit is leaked to the outside, the alumni information management unit may be a means for re-authenticating an individual through alumni information that is not generally public. The alumni information management unit may build a double security device of receiving and storing detailed alumni information such as the graduation year number, the class number for each year, the name of the class teacher, etc. in the information management server S and permitting a member subscription of only a person who inputs the detailed alumni information correctly. The alumni information management unit may automatically generate detailed alumni groups subordinate to an alumni group with respect to an index such as the class number for each year among the alumni information, thereby selecting a member who is closely acquainted with an alumni member who was in the same class and providing a weight to the selected member.

The history information management unit may manage the one or more pieces of history information among the job of the alumni member, the job group, the function, the rank, the responsible work, the main career, the license, and the motto. An alumni network is mostly used in the social life, and thus the history information may be the most important input item. The alumni member may acknowledge the history information such as the job of the another alumni member, the career, the responsible work, etc., acknowledge whether the history information is suitable for business that the alumni member needs, and make an appointment request, etc. based on this.

The social information management unit may manage the one or more pieces of social information among the blog address, the messenger identifier, the personal home page address, and the social network page address. Social information refers to social networking service information that has been recently developed. A social networking service is an extended online service of a social relationship network, for example, Twitter, LinkedIn, Pinterest, Pass, Vine, etc. The information management server S may further include the social information so that a user who exchanges information through a location-based alumni service may further obtain information of the corresponding user provided to an additional social network platform and may expand a mutual exchange range by making an online friendship relationship with the corresponding user in the additional social network platform. In particular, only a very limited activity may be allowed in view of the characteristic of the present invention oriented toward a closed social relationship network. The social information management unit may manage social network platform connection information of each alumni member, which induces a connection to an external platform, thereby inducing further various activities.

The location information management unit may manage the location information of the alumni member. The location information of the alumni member may be collected in real time. When each alumni member refuses to open his/her real time location information, it may be possible to manage location information of a particular time zone. The location information may be obtained by using a GPS, a mobile telecommunication relay station, etc. to acknowledge a current location of the alumni member.

The information management server S may further include an open location management unit that manages an open location information such that when the alumni member sets current location information to open to other alumni members, the current location information is open, and when the alumni member sets the current location information not to open to other alumni members, a preselected particular location (a location for each time zone, office, house, etc.) is open. The open location management unit may set the current location information to open via an ON/OFF command, when the command is set to OFF, the open location management unit may set the open location information such that location information set for each time zone such as a house, an office, a preference region, etc. may be open instead of the current location information. A location of the house before going to work and after work may be set. And a location of the office after going to work and before getting off work (during working hours) may be set. A main residence region of the alumni member, a visit region, a preference region, etc. may be preset and open. The location-based alumni business building system provides information about an alumni member based on a location to a particular alumni member. Thus, an option item may be set to allow the alumni member to personally manage whether to open the information about himself/herself or not.

The location information display unit may display the open location information of the alumni member on the screen map for one or more alumni groups among the elementary school alumni group, the middle school alumni group, the high school alumni group, the undergraduate school alumni group, and the graduate school alumni group. A current location or a particular location for each preselected time zone may be displayed as the open location information of the alumni member. Location information, personal information, history information, alumni information, social information, status information, schedule information, etc. of other alumni members near the current location or the particular location may be displayed when an icon is clicked on the map. The alumni member may be displayed in various shapes such as a symbol, a character, animal, plant, a name, a nickname, etc. The map may be expanded or reduced on the screen by adjusting and utilizing a distance such as a scale, a 100 m radius, a 500 m radius, a 1 km radius, etc. or by utilizing a domestic administrative district such as a metropolitan city, a megalopolitan city, cities and counties, eup/myeon/dong, etc. and a foreign administrative district. A local map showing only an alumni group of the alumni member according to levels, and a movement from a Korean map showing alumni members of other alumni groups who graduated from different schools to a world map may be possible.

The schedule information management unit may allow a user of the system according to the present invention to manage a schedule. For example, the schedule information may include a birthday of the alumni member, an anniversary, a holiday schedule, a business trip schedule, a business appointment schedule (Franklin planner function embedded), etc. A notification according to an input schedule may be provided to a computer of a user or a mobile device. The schedule information management unit may function to assist in arranging a different schedule at a time zone in which no schedule is input to the computer of the user or the mobile device. The schedule information management unit may perform a personal secretary role, may share particular schedule information between other alumni members, may utilize to make a business appointment with another alumni member, and may deliver notifications regarding an appointment and a schedule via e-mail, a push message of the mobile device, a text message, etc.

The status information management unit may display status information of the alumni member. The status information of the status information management unit may be information indicating a status of the alumni member such as the meeting status, the driving status, the working status, the consulting status, the lecturing status, the tired status, the gloomy status, the busy status, the leisure status, and the conversation available status. Such status information may be set so that when another alumni member requests business, a user may change user's status information to the driving status, the meeting status, etc., thereby providing an additional response like rejecting or delaying a business request of another alumni member. The alumni member may input the schedule information or the status information of the alumni member to the system according to the present invention. An input may be manually performed by the user or may be automatically performed by synchronizing schedule information or status information of another schedule management application of the computer or the mobile device with the schedule information management unit and the status information management unit of the system according to the present invention.

The information management server S may further include the business management unit that manages the one or more pieces of business information among the theme of business requiring help of another alumni member in association with the job of the alumni member or the responsible work, the advice on the business, the information arranging the meeting regarding the business, and the place information of the meeting.

The business management unit may function to arrange meetings between alumni members, and upload to a server and manage information regarding place information of an accomplished meeting, schedule information, a meeting theme, etc. The stored business information may be delivered to corresponding alumni members as a notification when the corresponding schedule approaches. The notification may be delivered via e-mail, a push message of the mobile device, a text message, etc. The business information may be open to a main timeline, etc. of the location-based alumni information business building system according to the present invention and may be not open according to opinion of alumni members who join a business. The business information of the alumni member, the schedule information, the status information, etc. may be acknowledged. An appointment may be requested on a date or at a time when no schedule is arranged in order to support business to be carried out. The business information may be information relating to the job of the alumni member, the theme of a business requiring help from another alumni member in association with the job of the alumni member or the responsible work, the advice on the business, useful information, the information about the meeting regarding the business, etc.

The information management server S may include the open setting unit that manages whether to open the one or more pieces of information among the personal information, the history information, the alumni information, the social information, the schedule information, and the business information. The open setting unit may set whether to open the personal information, the history information, the alumni information, the social information, the schedule information, and the business information, so that unwanted information may be avoided to open, and a business building activity according to a goal may be controlled to be made. The alumni member may divide and manage other alumni members as close alumni, general alumni, etc. according to intimacy with the alumni member and may differently set an information open range. The personal information, the history information, the alumni information, the social information, the schedule information, and the business information may also be differently set to open according to the close alumni, the general alumni, etc.

The open location management unit may manage the open location information such that when the user sets not to open particular information, the preselected particular location for each time zone is open. The alumni member may set a search exposure environment by using the open location management unit. Thus, the user may set the main residence region, the visit region, the preference region, etc. in advance to allow the user to be searched in the corresponding region. Only alumni who joined the location-based alumni business building system that is the present invention may be allowed to search. Alumni members of other alumni groups who graduated from other schools may acknowledge a location only when they are recommended by alumni members with a predetermined higher level.

The alumni member may set an information notification via e-mail or the push message of the mobile device by using the open location management unit. Thus, when a current location of the alumni member or a main residence region, etc., is preset, and when another alumni member approaches a set location or enters a set region, the information notification including a fact that another alumni member is present in a neighboring region, a profile of another alumni member, schedule information regarding how long another alumni member is present in the corresponding location, etc. may be provided to the alumni member who sets the information notification. When another alumni member blocks to open information, the information notification described above may not be provided.

The information management server S may further include a board management unit that may post content regarding a particular theme between the alumni members. A board may be in a form such as various themes including business related news and marketing, a sports day, a regular gathering, a small gathering, a job gathering, a region gathering, a closed gathering, etc. When a particular alumni member posts a notice on the board, a push notification or e-mail may be provided to another alumni member who has a particular relationship with the corresponding user.

The information management server S may further include a feedback management unit that manages a review on business between alumni members, episode, or a service evaluation. The review on business between alumni members, the episode, or the service evaluation may be factors that greatly influence levels of alumni members and activation of business in the future. The review on business between alumni members, the episode, or the service evaluation may induce participation of other interest alumni members. As the number of alumni members who read, evaluate, and participate reviews on open business increases, a level of an alumni member who proposed the corresponding business may increase. Thus, such feedback information should be efficiently managed by the information management server S, and the feedback management unit may provide a separate feedback score in order to improve the level of the alumni member who proposed the corresponding business. Only feedback regarding business proposed and accomplished for each alumni member may be separately put together and linked to an alumni member profile, thereby providing information such that other alumni members may know business with which the corresponding alumni member and another alumni member proceeded.

The information management server S may further include a level management unit that controls an information access by dividing a member authority based on one or more pieces of information among business proposal number of times of an alumni member, a business activity number of times, a business evaluation score, a preference score, and a feedback score and manages a level of the alumni member to show an alumni member of a different alumni group who graduated from a different school on a new map according to the level.

In conclusion, according to the present invention disclosing a closed type social networking service using an alumni member network, a user evaluation is a dramatically important service factor since other alumni members who hope to communicate or do business with the corresponding alumni member may increase according to an evaluation of an alumni member. For example, when two among three alumni members are alumni members who graduated from the same high school, and two are alumni members who graduated from different middle schools, since one alumni number has a qualification of alumni with the other alumni numbers, respectively, the one alumni member who know all may play a relay role according to a level to recommend middle school alumni members and high school alumni members to each other, and these members may be seen to meet on the new map and have a business relationship. Thus, the level may be provided by dividing an activity grade by a participation degree such as the business proposal number of times, the business activity number of times, the business evaluation score, the preference score, and the feedback score. The level management unit may divide the member authority based on a level division to control access to high rank information.

The information management server S may further include an alumni recommendation unit that recommends alumni members of different alumni groups who graduated from different schools according to the level divided by the level management unit, and if the alumni members permit to open each other's information, shows the alumni members on a new map to have a business relationship.

The present system basically sets alumni members who graduated from a particular school as an alumni group and displays the alumni group on a map. For example, an elementary school alumni group, a middle school alumni group, a high school alumni group, an undergraduate school alumni group, and a graduate school alumni group are separately present, alumni members are seen on regional and national maps (Korea map) within each alumni group, when a business score is high level, and alumni members of a different alumni group who graduated from a different school are shown together on a new map and are seen on the Korea map and a world map to have a business relationship in Korea and the world.

However, the level management unit may recommend alumni members of the different alumni group who graduated from the different school according to divided levels. For example, although alumni members who graduated from the same school may see each other's information in the middle school alumni group, and if they went to different high schools, since they have different high school alumni groups, they cannot see each other's information in the high school alumni group. A particular alumni member may recommend an alumni member of the middle school alumni group of the particular alumni member suitable for business required by an alumni member of the high school alumni group to the alumni member of the high school alumni group. The alumni members who receive recommendation may acknowledge their personal information, history information, social information, schedule information, status information, business information, etc. if they permit to open each other's information, may decide a schedule to see each other later, and may have a business relationship.

The present system may be applicable to both an application of a mobile device such as a smart phone, a tablet PC, or a smart watch, etc. or the Web used in a desk top computer, the mobile device, etc. For example, the application may be executed in the smart watch, and like the smart phone, and if a map is displayed on a screen of the smart watch, various functions of the present system may be performed.

The information management server S may further include a voice guiding unit that guides e-mail or a push message of a mobile device to an alumni member by voice. The voice guiding unit may perform a secretary function of notifying schedule information, business information, information of a different alumni member approaching a location indicated by open location information, etc. to the alumni member by voice. An arrival of the e-mail or the push message may be notified by voice, content of the e-mail or the push message may be read, and a presence of an alumni member approaching the location indicated by open location information may be notified by voice. If this function is utilized, the present system may be utilized in a status where a screen of the mobile device or the computer cannot be seen such as a driving status.

The information management server S may further include a wireless management unit that may wirelessly deliver various types of information such as alumni information of an alumni member, history information, etc. to a mobile device of another alumni member if mobile devices connect to each other at a near distance by using a near distance network transmission technology such as Bluetooth, NFC, etc. embedded in the mobile device such as the smart phone, the tablet PC, the smart watch, etc. If the wireless management unit is used, the basic alumni information and history information of the alumni member may be delivered to another alumni member to acknowledge each other's information. The delivered alumni information may be used to approve a member subscription for a particular alumni group of the alumni member.

The present system may be used by being connected to a smart phone docking system. The smart phone docking system may be utilized for various purposes such as voice input, voice output, data transmission, memory, charging, etc. including one or more means among a voice input means including a microphone, a voice output means including a speaker, and a data transmission means including a cable connecting the smart phone or the computer by wire. The microphone, the speaker, etc. included in the smart phone docking system may be used to input or output the schedule information, the business information, etc. to the location-based alumni business building system by voice. The cable connected to the smart phone docking system may be used for the data transmission and network connection between the computer and the mobile device such as the smart phone possible and may allow a screen on which a smart phone application is operating to be seen as a screen of the computer.

### MODE OF THE INVENTION

A location-based alumni business building method according to another embodiment of the present invention disclosing an information management server S linked to the Web and an application of a mobile device such as a smart phone, a smart watch, or a tablet PC and supporting business building between alumni members who graduated from a particular school by using a location-based alumni business building system comprises the information management server S acknowledging whether a user is an alumni member in relation to an identifier of the alumni member; the information management server S setting one or more alumni groups among an elementary school alumni group, a middle school alumni group, a high school alumni group, an undergraduate school alumni group, and a graduate school alumni group in relation to alumni information of the alumni member; determining to open information based on whether to open particular information including personal information of the alumni member, social information, schedule information, status information, and business information set by the open setting unit of the information management server S; the information management server S managing an open location information such that when the alumni member sets current location information to open to another alumni member, the current location information is open, and when the alumni member sets the current location information not to open, preset particular location information for each time zone is open; the information management server S providing open location information of the alumni member to another alumni member on a map of a screen for one or more alumni groups among the elementary school alumni group, the middle school alumni group, the high school alumni group, the undergraduate school alumni group, and the graduate school alumni group; the information management server S providing business information required by the alumni member to another alumni member; the information management server S notifying the business information or schedule information to alumni members who share the business information or the schedule information via e-mail or a push message of the mobile device; the information management server S providing a feedback including a review of business of the alumni member, an episode, or a service evaluation; and the information management server S controlling an information access by dividing a member authority based on one or more pieces of information among business proposal number of times of the alumni member, a business activity number of times, a business evaluation score, a preference score, and a feedback score and managing a level of the alumni member to show an alumni member of a different alumni group who graduated from a different school on a new map according to the level.

The information management server S acknowledging whether the user is the alumni member in relation to the identifier of the alumni member is an operation that is necessarily performed to use the system of the present invention and also is an operation of determining whether the user is the member in relation to the identifier or an ID of the alumni member. When the user is not the member, access is prohibited. Whether the user is the member or not may be determined by manually approving a member subscription by a manager of the system of the present invention. When a particular condition is satisfied by a particular algorithm, the member subscription may be automatically approved.

The information management server S setting one or more alumni groups among the elementary school alumni group, the middle school alumni group, the high school alumni group, the undergraduate school alumni group, and the graduate school alumni group in relation to the alumni information of the alumni member is an operation of placing the alumni member in a particular alumni group in relation to a graduated school name among the alumni information of the alumni group. The graduate school name may be different due to a change in a school name. However, to solve this problem, the method may further include configuring a current or past graduate school name database. Only alumni members grouped by a particular alumni group may search for or read each other's information. When the alumni member is not automatically grouped by the alumni group, the manager may add the alumni member to the alumni group.

The determining to open the information based on whether to open the particular information including the personal information of the alumni member, the social information, the schedule information, the status information, and the business information set by the open setting unit of the information management server S may be an operation of opening the particular information according to an open range set by the alumni member for him/herself.

The alumni member may divide and manage other alumni members as close alumni, general alumni, etc. according to intimacy with the alumni member and may differently set an information open range. For example, a current location of the alumni member may be open to the close alumni and a preset different location such as house, office, a preference region, etc. may be open to the general alumni. For example, the personal information, the social information, the schedule information, and the business information may be open to the close alumni, and only the basic alumni information may be open to the general alumni.

The information management server S manages the open location information such that when the alumni member sets the current location information to open to another alumni member, the current location information is open, and when the alumni member sets the current location information not to open, the preset particular location information for each time zone is open and the information management server S providing the open location information of the alumni member to another alumni member on the map of the screen for one or more alumni groups among the elementary school alumni group, the middle school alumni group, the high school alumni group, the undergraduate school alumni group, and the graduate school alumni group may be different when the alumni member sets the open location information. When the alumni member sets the current location information to open to another alumni member, the current location information is open. When the alumni member sets the current location information not to open, the preset particular location information for each time zone is open to another alumni member on the map of the screen for one or more alumni groups among the elementary school alumni group, the middle school alumni group, the high school alumni group, the undergraduate school alumni group, and the graduate school alumni group.

The business building method may further include the information management server S providing business information required by the alumni member to another alumni member.

The business building method may further include the information management server S notifying the business information or the schedule information to alumni members who share the business information or the schedule information via e-mail or the push message of the mobile device.

The business building method may further include the information management server S providing the feedback including the review of business of the alumni member, the episode, or the service evaluation.

The business building method may further include the information management server S controlling the information access by dividing the member authority based on one or more pieces of information among the business proposal number of times of the alumni member, the business activity number of times, the business evaluation score, the preference score, and the feedback score and managing the level of the alumni member to show the alumni member of the different alumni group who graduated from the different school on the new map according to the level.

The business building method may further include the information management server S recommending alumni members of different alumni groups who graduated from different schools according to the level divided in the managing of the level, and, if the alumni members permit to open each other's information, showing the alumni members on a new map to have a business relationship.

The business building method may further include, when another alumni member enters a region indicated by the open location information, the information management server S notifying the information about the entering to the alumni member via e-mail or'the push message of the mobile device by an open location management unit.

An example of displaying location information of a business building system through location-based alumni information according to an embodiment of the present invention is described. For example, if a first user using the system of the present invention accesses the information management server S by using a computer device such as a smart phone, a tablet PC, etc., a second user within a particular region may be determined based on a location of the first user. When the second user opens particular information, location information, alumni information, etc., of the first user, the first user may be notified via a pop-up icon, a push message, e-mail, a text message, etc. However, information of a third user beyond a range of the particular region may not be automatically transmitted to the first user. Another user notified to the computer device of the first user may be different according to a range of the region that is different according to a level of the first user. Alumni members of elementary school, middle school, high school, undergraduate school, and graduate school alumni groups of the first user may be displayed on a map at a basic level and may be expanded to regional and national maps. If a level of an alumni member using the system of the present invention increases, Korea and world maps may be expanded, alumni members of a different alumni group who graduated from a different school may be acknowledged, and building business relationship with more various alumni members may be possible. In this regard, the third user may be an alumni member of elementary school, middle school, high school, undergraduate school, and graduate school alumni groups of the first user and may be an alumni member of a different alumni group who graduated from a different school.

While this invention has been particularly shown and described with reference to preferred embodiments, it will be understood by those skilled in the art that various changes in form and details may be made therein without departing from the spirit and scope of the invention as defined by the appended claims. The preferred embodiments should be considered in a descriptive sense only and not for purposes of limitation. Therefore, the scope of the invention is defined not by the detailed description of the invention but by the appended claims

### INDUSTRIAL APPLICABILITY

A location-based alumnus business building system of the present invention has industrial applicability as a system for mutually exchanging business, marketing, information, and knowhow based on location information between alumni and providing feedback on mutual exchanges.

1. A location-based alumnus business building system comprising an information management server for building business between alumni members who graduated from a particular school, wherein the information management server is linked to Web and an application of a mobile device comprising a smart phone, a smart watch, or a tablet PC,
wherein the information management server comprises:
an alumni information management unit configured to manage one or more pieces of alumni information among a graduation school name of an alumni member, an entrance year, a graduation year, a past photo, a major, a nickname, a graduation year number, liberal arts or natural sciences, a class number for each year, a name of a class teacher or a nick name thereof, and a name of a teacher who is remembered or a nick name thereof;
a history information management unit configured to manage one or more pieces of history information among a job of the alumni member, a job group, a function, a rank, a responsible work, a main career, a license, and a motto;
a business management unit configured to manage one or more pieces of business information among a theme of business requiring help of another alumni member in association with the job of the alumni member or the responsible work, advice on the business, information arranging a meeting regarding the business, and place information of the meeting;
a feedback management unit configured to manage a review on business between alumni members, episode, or a service evaluation;
a level management unit configured to control an information access by dividing a member authority based on one or more pieces of information among business proposal number of times of an alumni member, a business activity number of times, a business evaluation score, a preference score, and a feedback score and manages a level of the alumni member to show an alumni member of a different alumni group who graduated from a different school on a new map according to the level;
a schedule information management unit configured to manage schedule information of the alumni member;
a status information management unit configured to manage one or more pieces of status information among a meeting status of the alumni member, a driving status, a working status, a consulting status, a lecturing status, a tired status, a gloomy status, a busy status, a leisure status, and a conversation available status;
a location information management unit configured to manage location information of the alumni member;
an open location management unit configured to manage an open location information such that when the alumni member sets current location information to open to other alumni members, the current location information is open, and when the alumni member sets the current location information not to open to other alumni members, preselected particular location information for each time zone is open; and
a location information display unit configured to display open location information of the alumni member on a screen as a map for one or more alumni groups among an elementary school alumni group, a middle school alumni group, a high school alumni group, an undergraduate school alumni group, and a graduate school alumni group,
wherein the business management unit or the schedule information management unit is further configured to notify business information or schedule information to alumni members who share the business information or the schedule information via e-mail or a push message of the mobile device.

2. The location-based alumnus business building system of claim 1, further comprising:
an alumni recommendation unit configured to recommend alumni members of a different alumni group who graduated from a different school according to the level divided by the level management unit and, if the alumni members permit to open each other's information, the alumni recommendation unit is configured to show the alumni members on a new map to have a business relationship.

3. The location-based alumnus business building system of claim 1, wherein the open location management unit, when another alumni member enters a region indicated by the open location information, is further configured to notify information including a fact that another alumni member is present in the region to the alumni member via e-mail or a push message of the mobile device.

4. A location-based alumni business building method of building business between alumni members by using the location-based alumni business building system of claim 1, the location-based alumni business building method comprising:
setting, by the information management server, one or more alumni groups among an elementary school alumni group, a middle school alumni group, a high school alumni group, an undergraduate school alumni group, and a graduate school alumni group in relation to alumni information of the alumni member;
managing, by the information management server, an open location information such that when the alumni member sets current location information to open to another alumni member, the current location information is open, and when the alumni member sets the current location information not to open, preset particular location information for each time zone is open;
providing, by the information management server, open location information of the alumni member to another alumni member on a map of a screen for one or more alumni groups among the elementary school alumni group, the middle school alumni group, the high school alumni group, the undergraduate school alumni group, and the graduate school alumni group;
providing, by the information management server, business information required by the alumni member to another alumni member;
notifying, by the information management server, the business information or schedule information to alumni members who share the business information or the schedule information via e-mail or a push message of the mobile device;
providing, by the information management server, feedback including a review of business of the alumni member, an episode, or a service evaluation; and
controlling, by the information management server, an information access by dividing a member authority based on one or more pieces of information among business proposal number of times of the alumni member, a business activity number of times, a business evaluation score, a preference score, and a feedback score and managing a level of the alumni member to show an alumni member of a different alumni group who graduated from a different school on a new map according to the level.

5. The location-based alumnus business building method of claim 4, further comprising:
recommending, by the alumni recommendation unit, alumni members of a different alumni group who graduated from a different school according to the level divided in the managing of the level, and, if the alumni members permit to open each other's information, showing, by the alumni recommendation unit, the alumni members on a new map to have a business relationship.

6. The location-based alumnus business building method of claim 4, further comprising:
when another alumni member enters a region indicated by the open location information, notifying, by the alumni recommendation unit, information including a fact that another alumni member is present in the region to the alumni member via e-mail or a push message of the mobile device.

7. The location-based alumnus business building system of claim 1, further comprising:
a voice guiding unit configured to guide e-mail or the push message of the mobile device to an alumni member by voice.

8. The location-based alumnus business building system of claim 1, further comprising: a wireless management unit configured to wirelessly deliver alumni information of an alumni member and history information to a mobile device of another alumni member if mobile devices connect to each other at a near distance by using a near distance network transmission technology.

9. The location-based alumnus business building system of claim 1, wherein the location-based alumnus business building system is used by being connected to a smart phone docking system comprising one or more means among a voice input means, a voice output means, and a data transmission means.
